(19) United States
(12) Patent Application Publication
(10) Pub. No.: US 2014/0112174 A1
(43) Pub. Date: Apr. 24, 2014

(54) COMMUNICATION DEVICE AND COMMUNICATING METHOD

(71) Applicant: Hon Hai Precision Industry Co., Ltd., New Taipei (TW)

(72) Inventor: CHIH-CHUN CHANG, New Taipei (TW)

(21) Appl. No.: 13/917,083

(22) Filed: Jun. 13, 2013

(30) Foreign Application Priority Data
Oct. 22, 2012 (TW) 101138938

(51) Int. Cl. H04L 12/931

(52) U.S. Cl. CPC H04L 49/205
USPC 370/252

(57) ABSTRACT

A communication device capable of automatically selecting to directly communicate with an external device using a first communication technology with a first predetermined bandwidth or indirectly communicate with the external device comprises a determining module, a detecting module, a comparing module, and a control module. The determining module generates a detecting signal when the communication device establishes a communication with an electronic device capable of using a second communication technology with a second predetermined bandwidth. The detecting module detects a remained bandwidth of the second communication technology in response to the detecting signal. When comparing module determines that the first predetermined bandwidth is less than the remained bandwidth, the control module controls the communication device communicate with the external device via the electronic device using the second communication technology.

### BACKGROUND

1. Technical Field

The present disclosure relates to communication devices, particularly to a communication device for automatically switching between a first communication technology and a second communication technology.

2. Description of Related Art

Most mobile telephones can communicate with an external device by using different protocols or access technology such as Global System for Mobile Communication (GSM) or Wireless-Fidelity (WI-FI). However, the mobile telephone may not be able to automatically select which communication technology has the higher speed.

Therefore, there is room for improvement in the art.

### BRIEF DESCRIPTION OF THE FIGURE

Many aspects of the embodiments can be better understood with reference to the following drawings. The components in the drawings are not necessarily drawn to scale, the emphasis instead being placed upon clearly illustrating the principles of the communication device and method thereof Moreover, in the drawings, like reference numerals designate corresponding parts throughout the several views.

FIG. 1 is a block diagram of a communication device in accordance with an embodiment.

FIG. 2 is a flowchart of a communicating method in accordance with the embodiment.

### DETAILED DESCRIPTION

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

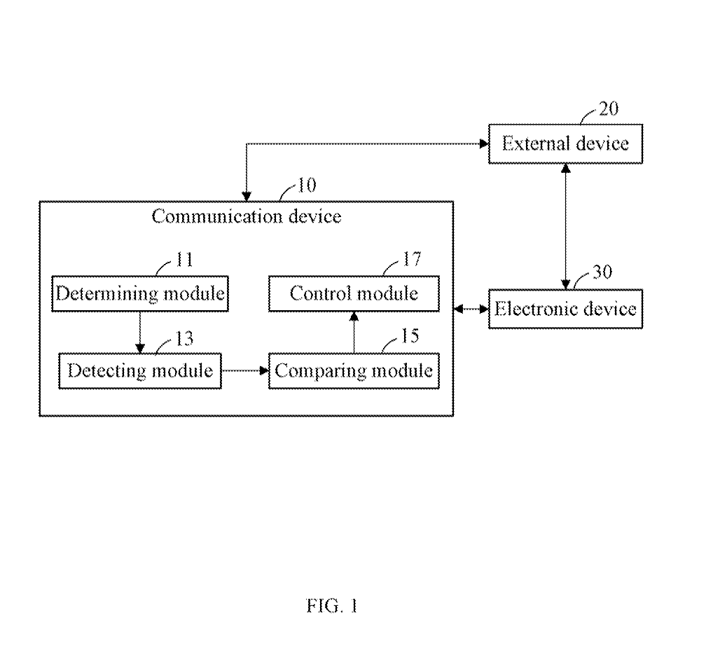

FIG. 1 shows a communication device 10 of the embodiment. The communication device 10 is capable of directly communicating with an external device 20 using a first communication technology (such as 3G) with a first predetermined bandwidth (such as 3M bps). The communication device 10 is also capable of communicating with an electronic device 30 which communicates with the external device 20 using a second communication technology (such as fiber cable) with a second predetermined bandwidth (such as 30M bps). The second predetermined bandwidth is greater than the first predetermined bandwidth. The communication device 10 is capable of automatically selecting one of a first manner and a second manner to communicate with the external device 20. In the first manner, the communication device 10 directly communicates with the external device 20 by using the first communication technology. In the second manner, the communication device 10 indirectly communicates with the external device 20 via the electronic device 30 by using the second communication technology. In the embodiment, the communication device 10 is a mobile phone, the external device 20 is a server or another communication device 10, and the electronic device 30 is a set-top box or a computer; the first communication technology is a mobile communication technology, such as 2G or 3G; the second communication technology is a wired communication technology, such as broadband cable or fiber cable.

The communication device 10 includes a determining module 11, a detecting module 13, a comparing module 15, and a control module 17.

The determining module 11 determines whether the communication device 10 establishes a communication with the electronic device 30, and generates a detecting signal when the communication device 10 establishes communication with the electronic device 30. In the embodiment, the communication device 10 is directly inserted into the electronic device 30 via a micro USB type or a mini USB type socket. In other embodiments, the communication device 10 establishes a communication with the electronic device 30 wirelessly, such as via WIFI function.

The detecting module 13 detects a currently used bandwidth of the second communication technology used by the electronic device 30 and calculates a difference between the second predetermined bandwidth and the currently used bandwidth to obtain a remained bandwidth. In the embodiment, the comparing module 15 controls the electronic device 30 to execute a program for detecting the currently used bandwidth of the second communication technology used by the electronic device 30.

The comparing module 15 determines whether the first predetermined bandwidth is less than the remained bandwidth. When the first predetermined bandwidth is determined to be less than the remained bandwidth, the comparing module 15 generates a first control signal; when the first predetermined bandwidth is determined to be equal to or greater than the remained bandwidth, the comparing module 15 generates a second control signal.

The control module 17 controls the communication device 10 to indirectly communicate with the external device 20 via the electronic device 30 by using the second communication technology (in the second manner) in response to the first control signal, and controls the communication device 10 to directly communicate with the external device 20 by using the first communication technology (in the first manner) in response to the second control signal.

In one embodiment, the communication device 10 communicates with the external device 20 based on a 3G communication technology with a 3M bps predetermined bandwidth; the electronic device 30 communicates with the external device 20 based on a fiber cable with a 8M bps predetermined bandwidth. When the currently used bandwidth used by the electronic device 30 is less than the 8M bps, such as 4M bps; the remained bandwidth is larger than the bandwidth of the communication device 10, thus the communication device 10 communicates with the external device 20 via the electronic device 30.

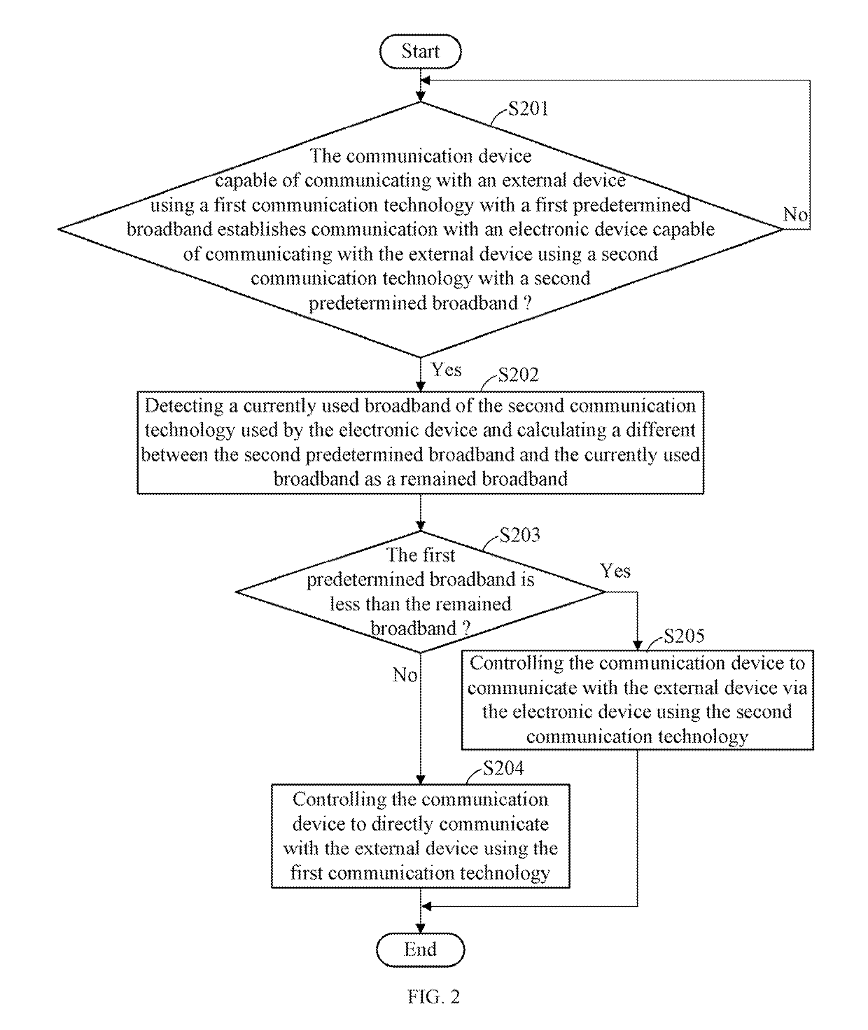

FIG. 2 shows a communicating method applied to a communication device 10 capable of communicating with an external device 20 by using a first communication technology with a first predetermined bandwidth and capable of communicating with an electronic device 30, which is capable of communicating with the external device 20 by using a second communication technology with a second predetermined bandwidth. The communicating method is used for automatically selecting one of a first manner and a second manner to communicate with the external device 20. In the first manner, the communication device 10 directly communicates with the external device 20 by using the first communication technology. In the second manner, the communication device 10 indirectly communicates with the external device 20 via the electronic device 30 by using a second communication technology. The second predetermined bandwidth is greater than the first predetermined bandwidth. In the embodiment, the communication device 10 is a mobile phone, the electronic device 30 is a television or a computer;

the first communication technology is a mobile communication technology, such as 2G or 3G, and the second communication technology is a wired communication technology, such as bandwidth cable or fiber cable. The communicating method includes the following steps.

In step S301, the determining module 11 determines whether the communication device 10 establishes a communication with the electronic device 30. If the communication device 10 establishes a communication with the electronic device 30, a detecting signal is generated and the procedure goes to S302; if the communication device 10 does not establish a communication with the electronic device 30, step S301 is repeated. In the embodiment, the communication device 10 as shown in FIG. 2 is directly inserted into a slot (not shown) on the top of the electronic device 30 for establishing a wired communication with the electronic device 30. In other embodiments, the communication device 10 establishes a communication with the electronic device 30 wirelessly.

In step S302, in response to the detecting signal the detecting module 13 detects a currently used bandwidth of the second communication technology used by the electronic device 30 and calculates a difference between the second predetermined bandwidth and the currently used bandwidth to obtain an remained bandwidth.

In step S303, the comparing module 15 determines whether the first predetermined bandwidth is less than the remained bandwidth. If the first predetermined bandwidth is determined to be less than the remained bandwidth, a first control signal is generated and the procedure goes to S304; if the first predetermined bandwidth is determined to be equal to or greater than the remained bandwidth, a second control signal is generated and the procedure goes to S302.

In step S304, in response to the first control signal, the control module 17 controls the communication device 10 to communicate the external device 20 via the electronic device using the second communication technology.

In step S305, in response to second control signal, the control module 17 controls the communication device 10 to directly communicate the external device 20 using the first second communication technology.

In use, the communication device 10 automatically selects directly communication with the external device 20 using the first communication technology or indirectly communication with the external device 20 via the electronic device 30 using the second communication technology, such that the data transmitting speed of the communication device 10 is improved.

While various embodiments have been described, the disclosure is not to be limited thereto. Various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. A communication device capable of automatically selecting directly communication with an external device using a first communication technology with a first predetermined bandwidth or indirectly communication with the external device via an electronic device; the communication device comprising:
a determining module configured to determine whether the communication device establishes a communication with an electronic device capable of using a second communication technology with a second predetermined bandwidth and generate a detecting signal when the communication device establishes a communication with the electronic device;
a detecting module configured to detect a remained bandwidth of the second communication technology in response to the detecting signal;
a comparing module configured to determine whether the first predetermined bandwidth is less than the remained bandwidth; and
a control module configured to control the communication device to communicate with the external device via the electronic device using the second communication technology when the first predetermined bandwidth is less than the remained bandwidth.

2. The communication device of claim 1, wherein the first communication technology is a wireless communication technology.

3. The communication device of claim 1, wherein the second communication technology is a wired communication technology.

4. The communication device of claim 1, wherein the communication device is inserted into a slot on the top of the electronic device.

5. The communication device of claim 1, wherein the communication device establishes a communication with the electronic device wirelessly.

6. The communication device of claim 1, wherein when the comparing module determines that the first predetermined bandwidth is equal to or greater than the remained bandwidth, the control module controls the communication device to directly communicate the external device using the first communication technology.

7. The communication device of claim 1, wherein the second predetermined bandwidth is greater than the first predetermined bandwidth.

8. The communication device of claim 1, wherein the detecting module detects a currently used bandwidth of the second communication technology used by the electronic device, and calculates a difference between the second predetermined bandwidth and the currently used bandwidth to obtain the remained bandwidth.

9. A communicating method for automatically controlling a communication device to directly communicate an external device using a first communication technology with a first predetermined bandwidth or indirectly communicate the external device ;
the communication device comprising:
determining whether the communication device establishes a communication with an electronic device capable of using a second communication technology with a second predetermined bandwidth;
obtaining a remained bandwidth of the second communication technology when the communication device established the communication with an electronic device;
comparing the first predetermined bandwidth with the remained bandwidth;
generating a first control signal when the first predetermined bandwidth is less than the remained bandwidth; and
controlling the communication device to communicate with the external device via the electronic device using the second communication technology in response to the first control signal.

10. The communicating method of claim 9, wherein when the first predetermined bandwidth is equal to or greater than the remained bandwidth, controlling the communication device directly communicate with the external device using the first communication technology.

11. The communicating method of claim 9, wherein the first communication technology is a wireless communication technology.

12. The communicating method of claim 9, wherein the second communication technology is a wired communication technology.

13. The communicating method of claim 9, wherein the communication device is inserted into a slot on the top of the electronic device.

14. The communicating method of claim 9, wherein the communication device establishes a communication with the electronic device wirelessly.

15. The communicating method of claim 9, wherein the second predetermined bandwidth which is greater than the first predetermined bandwidth.

16. The communicating method of claim 9, wherein the detecting module detects a currently used bandwidth of the second communication technology used by the electronic device, and calculates a difference between the second predetermined bandwidth and the currently used bandwidth to obtain the remained bandwidth.
